(19) United States
(12) Patent Application Publication
(10) Pub. No.: US 2011/0278103 A1
(43) Pub. Date: Nov. 17, 2011

(54) ANTI-WEARING BRAKE DISK

(76) Inventor: Wayne-Ian Moore, Changhua County (TW)

(21) Appl. No.: 13/033,609

(22) Filed: Feb. 24, 2011

(30) Foreign Application Priority Data
May 12, 2010 (TW) 099115136

(51) Int. Cl. B62L 1/00; F16D 65/12

(52) U.S. Cl. 188/26

(57) ABSTRACT

A brake system for a bicycle includes a brake disk having an anti-wearing portion formed thereon and two brake members each have an anti-wearing portion formed thereon which is in contact with the anti-wearing portion of the brake disk when braking the bicycle. The two respective anti-wearing portions are made by plastic or rubber which is heated and pressed to be attached to at least one of two sides of the brake disk 1 and the two brake members such that the brake disk quickly responds to the braking action and has longer life of use.

### FIELD OF THE INVENTION

The present invention relates to a brake disk, and more particularly, to a brake disk with anti-wearing portion formed along two sides of the periphery and the brake members each have the anti-wearing portion so as to prolong the life of use of the brake disk.

### BACKGROUND OF THE INVENTION

The conventional sport bicycles such as performance bikes and mountain bikes are required to have shape braking feature so as to stop the bicycles as desired and this ensures the safety of operation of the bicycles.

The conventional brake system for the bicycles generally includes a brake disk and two brake members which clamp the brake disk to stop the rotation of the wheels. Each of the brake members has a body and a brake shoe which is engaged with slots defined in one side of the body, and the brake shoe includes multiple protrusions which are securely engaged with the slots so as to ensure that the brake shoe is not disengaged from the body when braking. The protrusions also reduce the temperature generated due to friction when braking.

However, the conventional brake shoe simply achieves the purpose of securely connected to the body. The brake disk is made by aluminum alloy or iron, wherein the aluminum alloy is light but can be worn out quickly. On the contrary, the iron-made disk can bear friction but is heavy. The brake shoe contacts the brake disk to stop the wheel, wherein there is nothing to the brake disk to be in contact with the brake member so that the brake disk is easily worn out. The coating of the aluminum alloy disk is easily worn out and the iron brake disk generates high temperature to soften the brake member. Either reduces the braking function of the brake system so that how to obtain a brake disk that is light and durable is important.

The present invention intends to provide a brake disk which has an anti-wearing portion formed on two sides thereof and the brake members each have the anti-wearing portion so as to precisely contact the anti-wearing portion of the disk.

### SUMMARY OF THE INVENTION

The present invention relates to a brake disk for a bicycle and comprises a brake disk having an anti-wearing portion formed thereon and the anti-wearing portion is made by plastic or rubber which is heated and pressed to be attached to at least one of two sides of the brake disk. Two brake members each have an anti-wearing portion formed thereon which is in contact with the anti-wearing portion of the brake disk. The respective anti-wearing portions of the brake disk and the brake members are in contact with each other to evenly brake the disk and provide sharp brake features. The brake disk has longer life of use.

Preferably, the anti-wearing portion on the brake disk and the anti-wearing portion of each of the brake members are made by identical materials.

Preferably, the anti-wearing portion on the brake disk and the anti-wearing portion of each of the brake members are made by different materials.

The primary object of the present invention is to provide a brake disk which has an anti-wearing portion formed thereon so as to improve the shortcomings of the conventional brake disk.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the brake disk and the brake members of the present invention;

FIG. 2 is a side view of the brake disk of the present invention, and

FIG. 3 is a cross sectional view to show that the two brake members are located on two sides of the brake disk of the present invention.

### DETAILED DESCRIPTION OF THE PREFERRED EMBODIMENT

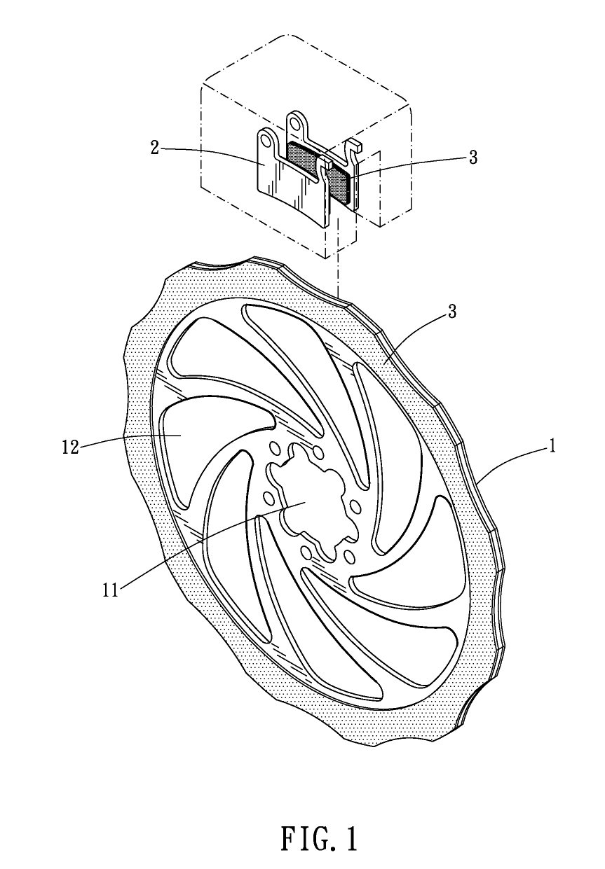

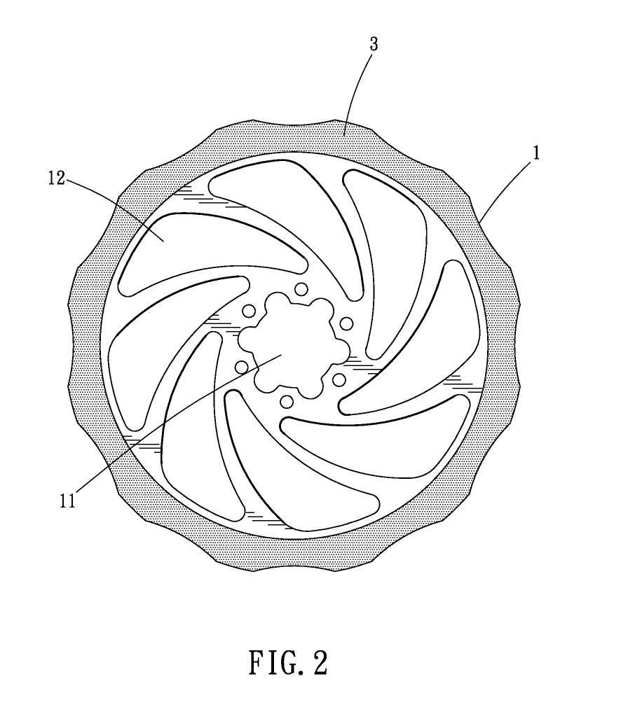

Referring to FIGS. 1 and 2, the brake system for a bicycle of the present invention comprises a brake disk 1 and at least one brake member 2, wherein the brake disk 1 and the at least one brake member 2 each have an anti-wearing portion 3 formed thereon and the anti-wearing portion 3 is made by plastic or rubber which is heated and pressed to be attached to at least one of two sides of the brake disk 1 and the at least one brake member 2. In this embodiment, there are two brake members 2. The brake disk 1 is a circular disk and includes an installation hole 11 defined centrally therethrough and multiple openings 12 are defined through the brake disk 1 and located around the installation hole 11. The size of each of the openings 12 gradually reduced from outer portion toward the center of the brake disk 1. The anti-wearing portion 3 is located on each side of the periphery of the brake disk 1 and the openings 12 are enclosed by the anti-wearing portion 3.

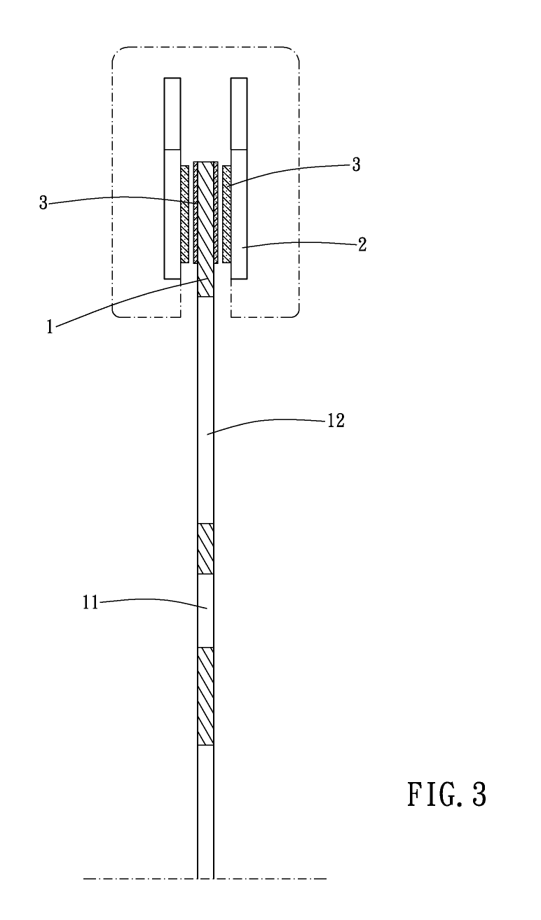

As shown in FIG. 3, by contact between the anti-wearing portions 3 on the brake disk 1 and the anti-wearing portions 3 of the two brake members 2, the frictional force is evenly applied to the brake disk 1 which is then stopped sharply to respond to the braking action. The brake disk 1 can be used for a longer life of use.

Furthermore, the anti-wearing portions 3 on the brake disk 1 and the anti-wearing portion 3 of each of the brake members 2 are made by identical materials so that the respective anti-wearing portions 3 have the same friction coefficient and the brake force is even and steady, and the anti-wearing portions 3 can be used for a longer period of time.

Alternatively, the anti-wearing portions 3 on the brake disk 1 and the anti-wearing portion 3 of each of the brake members 2 are made by different materials. The respective anti-wearing portions 3 have different friction coefficients and brake disk 1 can be stopped fast and efficiently.

The brake disk 1 and the brake members 2 have the anti-wearing portions 3 which are made by plastic or rubber which is heated and pressed to be attached to the brake disk 1 and the brake members 2. The brake disk 1 and the brake members 2 improve the shortcomings of the conventional brake disk and the brake members.

While we have shown and described the embodiment in accordance with the present invention, it should be clear to those skilled in the art that further embodiments may be made without departing from the scope of the present invention.

What is claimed is:

1. A brake system for a bicycle, comprising:
a brake disk having an anti-wearing portion formed thereon and the anti-wearing portion being made by plastic or rubber which is heated and pressed to be attached to at least one of two sides of the brake disk, and
two brake members each having an anti-wearing portion formed thereon which is in contact with the anti-wearing portion of the brake disk.

2. The brake system as claimed in claim 1, wherein the anti-wearing portion on the brake disk and the anti-wearing portion of each of the brake members are made by identical materials.

3. The brake system as claimed in claim 1, wherein the anti-wearing portion on the brake disk and the anti-wearing portion of each of the brake members are made by different materials.
